(19) United States
(12) Patent Application Publication
(10) Pub. No.: US 2023/0262314 A1
(43) Pub. Date: Aug. 17, 2023

(54) LENS DRIVING MECHANISM

(71) Applicant: FUJIFILM Corporation, Tokyo (JP)

(72) Inventors: Takeya ABE, Saitama-shi (JP); Shinji OTSUKA, Saitama-shi (JP); Azuchi ENDO, Saitama-shi (JP)

(73) Assignee: FUJIFILM Corporation, Tokyo (JP)

(21) Appl. No.: 18/168,407

(22) Filed: Feb. 13, 2023

(30) Foreign Application Priority Data
Feb. 14, 2022 (JP) 2022-020402

(51) Int. Cl. H04N 23/57; G02B 7/04; H02N 2/02

(52) U.S. Cl. CPC H04N 23/57; G02B 7/04; H02N 2/025

(57) ABSTRACT

A lens driving mechanism includes first and second piezoelectric rods that move a lens and first and second sensors that detect a position of the lens. An angle formed between a line (a first piezoelectric line) that extends from the first piezoelectric rod to be perpendicular to an optical axis and a line (a first sensor line) that extends from the first sensor to be perpendicular to the optical axis is smaller than 90°. An angle formed between a line (a second piezoelectric line) that extends from the second piezoelectric rod to be perpendicular to the optical axis and a line (a second sensor line) that extends from the second sensor to be perpendicular to the optical axis is smaller than 90°.

### CROSS-REFERENCE TO RELATED APPLICATIONS

This application claims priority under 35 U.S.C § 119(a) to Japanese Patent Application No. 2022-020402 filed on 14 Feb. 2022. The above application is hereby expressly incorporated by reference, in its entirety, into the present application.

### BACKGROUND OF THE INVENTION

### 1. Field of the Invention

The present invention relates to a lens driving mechanism.

### 2. Description of the Related Art

Described in WO2019/083087A (corresponding to US2020/0348485A1) is a configuration in which two shafts that engage with a lens via a frictional force and two piezoelectric elements respectively corresponding to the shafts are provided and the shafts are caused to vibrate by the respective piezoelectric elements so that the lens is moved in an optical axis direction.

Described in JP5517431B (corresponding to US2010/0079604A1) is a configuration in which a lens having a floating structure is pulled by a magnetic force so that inclination of the lens is corrected.

### SUMMARY OF THE INVENTION

An embodiment according to the present disclosed technology provides a small-size lens driving mechanism with which it is possible to correct inclination of a lens.

A lens driving mechanism according to an aspect of the present disclosed technology includes a first shaft and a second shaft that engage with a lens via a frictional force, a first piezoelectric element that causes the first shaft to vibrate so that the lens is moved in an optical axis direction, a second piezoelectric element that causes the second shaft to vibrate so that the lens is moved in the optical axis direction, a first sensor and a second sensor that detect a position of the lens in the optical axis direction, and a lens control device that controls the position and/or an angle of the lens based on output of the first sensor and the second sensor.

It is preferable that an angle formed between a first piezoelectric line and a first sensor line is smaller than 90° and an angle formed between a second piezoelectric line and a second sensor line is smaller than 90°, the first piezoelectric line being a line that is drawn from the first shaft to be perpendicular to an optical axis of the lens, the first sensor line being a line that is drawn from the first sensor to be perpendicular to the optical axis, the second piezoelectric line being a line that is drawn from the second shaft to be perpendicular to the optical axis, and the second sensor line being a line that is drawn from the second sensor to be perpendicular to the optical axis.

It is preferable that an angle formed between the first piezoelectric line and the second piezoelectric line is larger than 90° and an angle formed between the first sensor line and the second sensor line is larger than 90°.

It is preferable that the angle formed between the first piezoelectric line and the second piezoelectric line is 180°.

It is preferable that the angle formed between the first sensor line and the second sensor line is 180°.

A third shaft that engages with the lens via a frictional force and a third piezoelectric element that causes the third shaft to vibrate so that the lens is moved in the optical axis direction may be provided.

A third sensor that detects the position of the lens in the optical axis direction may be provided.

A third shaft that engages with the lens via a frictional force, a third piezoelectric element that causes the third shaft to vibrate so that the lens is moved in the optical axis direction, and a third sensor that detects the position of the lens in the optical axis direction may be provided.

It is preferable that an angle formed between a third piezoelectric line and a third sensor line is smaller than 90°, the third piezoelectric line being a line that is drawn from the third shaft to be perpendicular to the optical axis and the third sensor line being a line that is drawn from the third sensor to be perpendicular to the optical axis.

It is preferable that an angle formed between a third piezoelectric line and the first piezoelectric line and an angle formed between the third piezoelectric line and the second piezoelectric line are larger than 90°, the third piezoelectric line being a line that is drawn from the third shaft to be perpendicular to the optical axis.

It is preferable that an angle formed between a third sensor line and the first sensor line and an angle formed between the third sensor line and the second sensor line are larger than 90°, the third sensor line being a line that is drawn from the third sensor to be perpendicular to the optical axis.

### BRIEF DESCRIPTION OF THE DRAWINGS

FIG. 1 is an external view of a lens driving mechanism.

FIG. 2 is an exploded view of the lens driving mechanism.

FIG. 3 is an external view of a first sliding portion.

FIG. 4 is a front view of the lens driving mechanism.

FIG. 5 is a schematic front view of the lens driving mechanism.

FIG. 6 is a schematic front view of the lens driving mechanism.

FIG. 7 is a schematic front view of the lens driving mechanism.

### DESCRIPTION OF THE PREFERRED EMBODIMENTS

### First Embodiment

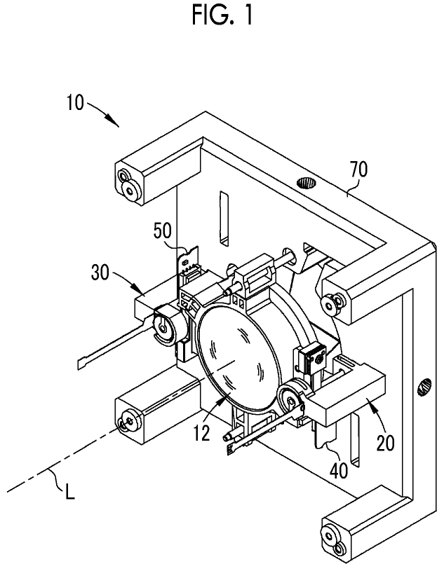

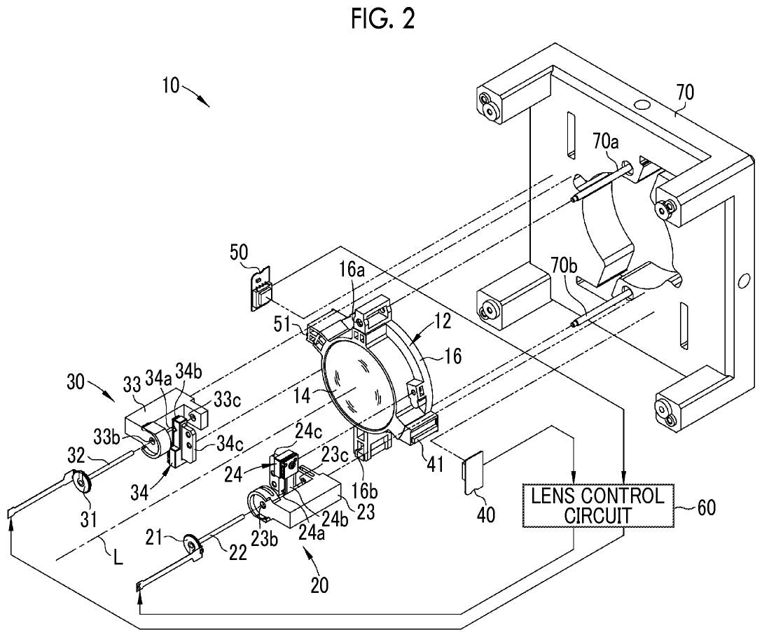

In FIG. 1 and FIG. 2, a lens driving mechanism 10 is installed in an imaging device such as a digital camera, a smartphone, or a video camera, for example. The lens driving mechanism 10 includes a lens unit 12. The lens unit 12 is obtained by integrating a lens 14 and a lens holding frame 16 with each other and is moved in a direction along an optical axis L of the lens 14 in the case of a focusing operation or a zooming operation, the lens holding frame 16 holding the lens 14.

In addition to the lens unit 12 described above, the lens driving mechanism 10 includes a first driving unit 20, a second driving unit 30, a first sensor 40, a second sensor 50, and a lens control circuit 60 (a lens control device). Each of the components of the lens driving mechanism 10 is attached to a base 70. The base 70 supports each of the components attached thereto and is fixed to a device in which the lens driving mechanism 10 is installed.

The base 70 is provided with slide shafts 70a and 70b parallel to the optical axis L, and the lens unit 12 (the lens holding frame 16) is provided with slide holes 16a and 16b into which the slide shafts 70a and 70b are inserted. The lens unit 12 is supported to be slidable in the direction along the optical axis L with the slide shaft 70a inserted into the slide hole 16a and the slide shaft 70b inserted into the slide hole 16b.

The first driving unit 20 includes a first piezoelectric element 21, a first piezoelectric rod 22 (a first shaft), a first support frame 23, and a first sliding portion 24. The first piezoelectric element 21 is formed in a disk-like shape and is disposed in a state where a plate surface is perpendicular to the optical axis L. The first piezoelectric element 21 is curved (deformed) such that the shape thereof is changed from the disk-like shape to a bowl-like shape in a case where a voltage is applied thereto. The direction of deformation (whether the first piezoelectric element 21 is curved forward or curved rearward in the direction along the optical axis L) and the speed of deformation of the first piezoelectric element 21 are changed depending on the state of voltage application (the direction of application, the time of a rise, and the time of a fall).

The first piezoelectric rod 22 is formed to be long in the direction along the optical axis L and a distal end thereof is fixed to a plate surface central portion of the first piezoelectric element 21. In addition, the first piezoelectric rod 22 moves (vibrates) in the direction along the optical axis L as the first piezoelectric element 21 is deformed.

The first support frame 23 is fixed to the base 70. The first support frame 23 has a U-shaped cross section in the direction along the optical axis L. A through hole 23b is formed on a front side in the direction along the optical axis L and a through hole 23c is formed on a rear side in the direction along the optical axis L with a U-shaped opening portion interposed therebetween. A front end side of the first piezoelectric rod 22 is inserted into the through hole 23b and a rear end side of the first piezoelectric rod 22 is inserted into the through hole 23c. In addition, the front end side and the rear end side of the first piezoelectric rod 22 are respectively connected to the through hole 23b and the through hole 23c via an adhesive having elasticity. Accordingly, the first piezoelectric rod 22 is supported to be vibratable (movable) in the direction along the optical axis L.

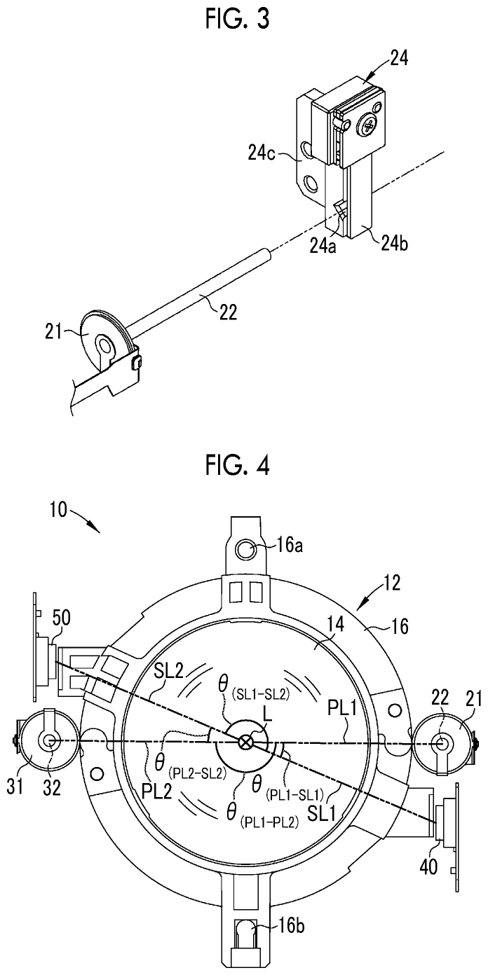

The first sliding portion 24 engages with a portion of the first piezoelectric rod 22 that is at a space between the through holes 23b and 23c via a frictional force. Specifically, as shown in FIG. 3, the first sliding portion 24 includes a cutout portion 24a of which a cross section perpendicular to the optical axis L has an L-like shape and a leaf spring 24b that is provided to close an opening portion of the cutout portion 24a. In addition, the first piezoelectric rod 22 is elastically deformed and inserted into a triangular columnar space formed between the cutout portion 24a and the leaf spring 24b to press and stretch the leaf spring 24b, is pressed against the cutout portion 24a by a restoring force of the leaf spring 24b, and engages with the cutout portion 24a and the leaf spring 24b via a frictional force therebetween.

The first sliding portion 24 includes a fixation portion 24c, and the fixation portion 24c is fixed to the lens holding frame 16 by being screwed or the like to be integrated with the lens unit 12 (the lens holding frame 16). The first driving unit 20 moves the lens unit 12 in the direction along the optical axis L by performing drive control of the first piezoelectric element 21 such that the position of engagement between the first piezoelectric rod 22 and the first sliding portion 24 is changed.

That is, since the lens unit 12 (the first sliding portion 24) engages with the first piezoelectric rod 22 via the frictional force, only the first piezoelectric rod 22 moves without movement of the first sliding portion 24 even in a case where the first piezoelectric rod 22 is moved at a high speed such that the frictional force is exceeded. However, in a case where the first piezoelectric rod 22 is moved at a low speed such that the frictional force is not exceeded, the first sliding portion 24 moves together with the first piezoelectric rod 22. By using the above fact, the first driving unit 20 performs drive control of the first piezoelectric element 21 (controls a voltage applied to the first piezoelectric element 21) to move the lens unit 12 (the first sliding portion 24) in the direction along the optical axis L.

Specifically, in a case where the lens unit 12 is to be moved forward in the direction along the optical axis L, the drive control of the first piezoelectric element 21 is performed and an operation of moving the first piezoelectric rod 22 forward in the direction along the optical axis L at a low speed and an operation of moving the first piezoelectric rod 22 rearward in the direction along the optical axis L at a high speed are performed (repeatedly). In addition, in a case where the lens unit 12 is to be moved rearward in the direction along the optical axis L, an operation of moving the first piezoelectric rod 22 forward in the direction along the optical axis L at a high speed and an operation of moving the first piezoelectric rod 22 rearward in the direction along the optical axis L at a low speed are performed (repeatedly).

Referring again to FIG. 2, as with the first driving unit 20 described above, the second driving unit 30 includes a second piezoelectric element 31, a second piezoelectric rod 32 (a second shaft), a second support frame 33, and a second sliding portion 34. In addition, the second support frame 33 has a U-shaped cross section in the direction along the optical axis L, a front end side thereof is provided with a through hole 33b, and a rear end side thereof is provided with a through hole 33c. In addition, a front end side and a rear end side of the second piezoelectric rod 32 are respectively inserted into the through hole 33b and the through hole 33c to be connected to the through holes 33b and 33c via an adhesive having elasticity, so that the second piezoelectric rod 32 is supported to be vibratable (movable) in the direction along the optical axis L.

Furthermore, the second sliding portion 34 includes a cutout portion 34a and a leaf spring 34b and the second piezoelectric rod 32 is inserted into a triangular columnar space formed between the cutout portion 34a and the leaf spring 34b and engages with the cutout portion 34a and the leaf spring 34b via a frictional force therebetween. In addition, the second sliding portion 34 includes a fixation portion 34c to be fixed to the lens unit 12 (the lens holding frame 16) and is integrated with the lens unit 12.

In addition, the second driving unit 30 performs drive control of the second piezoelectric element 31 (controls a voltage applied to the second piezoelectric element 31) to move the lens unit 12 (the second sliding portion 34) in the direction along the optical axis L. That is, in a case where the lens unit 12 is to be moved forward in the direction along the optical axis L, an operation of moving the second piezoelectric rod 32 forward in the direction along the optical axis L at a low speed and an operation of moving the second piezoelectric rod 32 rearward in the direction along the optical axis L at a high speed are performed (repeatedly). In addition, in a case where the lens unit 12 is to be moved rearward in the direction along the optical axis L, an operation of moving the second piezoelectric rod 32 forward in the direction along the optical axis L at a high speed and an operation of moving the second piezoelectric rod 32 rearward in the direction along the optical axis L at a low speed are performed (repeatedly).

The first sensor 40 is provided to detect the position of the lens 14 (the lens unit 12) and is fixed to the base 70. A first detection piece 41 is provided on an outer periphery of the lens holding frame 16, and the first sensor 40 outputs, to the lens control circuit 60, a signal indicating a positional relationship between the first sensor 40 and the first detection piece 41. Similarly, the second sensor 50 is also provided to detect the position of the lens 14 (the lens unit 12) and is fixed to the base 70. In addition, the second sensor 50 outputs, to the lens control circuit 60, a signal indicating a positional relationship between the second sensor 50 and a second detection piece 51 provided on the outer periphery of the lens holding frame 16.

The lens control circuit 60 detects the position and inclination of the lens 14 (the lens unit 12) based on a signal input thereto. In addition, the lens control circuit 60 drives the first driving unit 20 and the second driving unit 30 to control the position and inclination of the lens 14 by using the detected position and inclination of the lens 14. Specifically, the lens 14 is moved to a desired position (a position to which the lens 14 needs to be moved for a focusing operation or a zooming operation) in the direction along the optical axis L. In addition, in a case where the optical axis L of the lens 14 is inclined with respect to an imaging optical axis, the inclination is corrected.

As shown in FIG. 4, in the case of the lens driving mechanism 10 according to an embodiment of the present invention, an angle θ (PL1-SL1) formed between a first piezoelectric line PL1 and a first sensor line SL1 is smaller than 90°, the first piezoelectric line PL1 being a line that is drawn from the first piezoelectric rod 22 to be perpendicular to the optical axis L and the first sensor line SL1 being a line that is drawn from the first sensor 40 to be perpendicular to the optical axis L. That is, the first piezoelectric element 21 (the first piezoelectric rod 22) and the first sensor 40 (the first detection piece 41) are disposed such that the angle θ (PL1-SL1) formed between the first piezoelectric line PL1 and the first sensor line SL1 is smaller than 90°.

In addition, in the case of the lens driving mechanism 10 according to the embodiment of the present invention, an angle θ (PL2-SL2) formed between a second piezoelectric line PL2 and a second sensor line SL2 is smaller than 90°, the second piezoelectric line PL2 being a line that is drawn from the second piezoelectric rod 32 to be perpendicular to the optical axis L and the second sensor line SL2 being a line that is drawn from the second sensor 50 to be perpendicular to the optical axis L. That is, the second piezoelectric element 31 (the second piezoelectric rod 32) and the second sensor 50 (the second detection piece 51) are disposed such that the angle θ (PL2-SL2) formed between the second piezoelectric line PL2 and the second sensor line SL2 is smaller than 90°.

Since the angle θ (PL1-SL1) formed between the first piezoelectric line PL1 and the first sensor line SL1 is smaller than 90° and the angle θ (PL2-SL2) formed between the second piezoelectric line PL2 and the second sensor line SL2 is smaller than 90° (that is, the sensors are disposed relatively close to the piezoelectric rods (the piezoelectric elements)) as described above, the position (the inclination) of the lens 14 can be controlled with high accuracy. That is, the position (the inclination) of the lens 14 is changed as a force is supplied from the piezoelectric rods (the piezoelectric elements). Therefore, the closer positions at which the sensors are disposed are to the piezoelectric rods (the piezoelectric elements), the more accurately a change in position (inclination) of the lens 14 can be detected and the more suitable the positions are as disposition positions of the sensors. In addition, since the sensors are disposed at such suitable positions and detection is performed with high accuracy, the accuracy of control of the position (the inclination) of the lens 14 which is performed by using the detected position of the lens 14 is also improved.

Furthermore, in the case of the lens driving mechanism 10 according to the embodiment of the present invention, an angle θ (PL1-PL2) formed between the first piezoelectric line PL1 and the second piezoelectric line PL2 is larger than 90°. Accordingly (that is, since the piezoelectric rods (the piezoelectric elements) are disposed at angular positions around the optical axis L that are separated from each other), the inclination of the lens 14 can be corrected more reliably. That is, in a case where the piezoelectric rods (the piezoelectric elements) are arranged at angular positions close to each other, flexible control of the position of the lens 14 cannot be performed on a side opposite to a side on which the piezoelectric rods (the piezoelectric elements) are provided with respect to the optical axis L. However, such a problem can be prevented since the piezoelectric rods (the piezoelectric elements) are disposed at angular positions that are separated from each other. Note that it is preferable that the piezoelectric rods (the piezoelectric elements) are disposed at angular positions around the optical axis L that are 180° separated from each other (it is preferable that the angle θ (PL1-PL2) is 180°), and in the present embodiment, the piezoelectric rods are disposed in such a manner.

In addition, in the case of the lens driving mechanism 10 according to the embodiment of the present invention, an angle θ (SL1-SL2) formed between the first sensor line SL1 and the second sensor line SL2 is larger than 90°. Accordingly (that is, since the sensors are disposed at angular positions around the optical axis L that are separated from each other), the inclination of the lens 14 can be corrected more reliably. That is, in a case where the sensors are arranged at angular positions close to each other, the position of the lens 14 cannot be figured out and the inclination of the lens 14 cannot be detected in some cases on a side opposite to a side on which the sensors are provided with respect to the optical axis L. However, such a problem can be prevented since the sensors are disposed at angular positions that are separated from each other. Note that it is preferable that the sensors are disposed at angular positions around the optical axis L that are 180° separated from each other (it is preferable that the angle θ (SL1-SL2) is 180°), and in the present embodiment, the sensors are disposed in such a manner.

### Second Embodiment

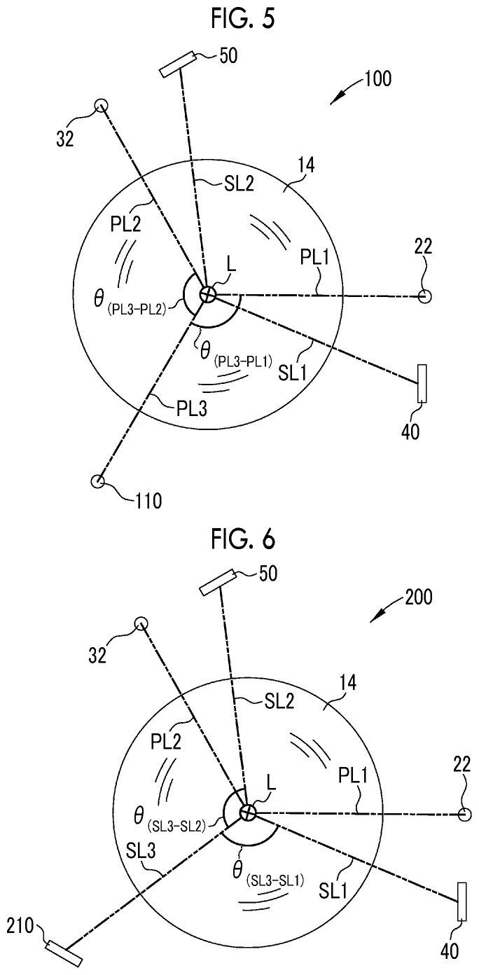

In the first embodiment described above, an example, in which a force from the two piezoelectric rods (the first and second piezoelectric rods 22 and 32) is supplied to two positions on an outer periphery of the lens 14 (the lens unit 12) so that the lens 14 is moved, has been described. However, the present invention is not limited thereto. As in the case of a lens driving mechanism 100 shown in FIG. 5, a configuration in which, a third piezoelectric rod 110 (a third shaft) is provided in addition to the two piezoelectric rods (the first piezoelectric rod 22 and the second piezoelectric rod 32) of the first embodiment and a force is supplied to three positions on the outer periphery of the lens 14 (the lens unit 12) so that the lens 14 is moved, may also be adopted. Note that in the description made with reference to FIG. 5 and subsequent drawings, the same members as those in the above-described embodiment are given the same reference numerals, and the description thereof will be omitted. In addition, FIG. 5 and subsequent drawings are simplified.

Note that in the case of a configuration in FIG. 5, it is preferable that an angle θ (PL3-PL1) formed between a third piezoelectric line PL3 and the first piezoelectric line PL1 is larger than 90° and an angle θ (PL3-PL2) formed between the third piezoelectric line PL3 and the second piezoelectric line PL2 is larger than 90°, the third piezoelectric line PL3 being a line that is drawn from the third piezoelectric rod 110 to be perpendicular to the optical axis L. In this case, the inclination of the lens 14 can be corrected more reliably.

### Third Embodiment

In the first embodiment described above, an example, in which the two sensors (the first and second sensors 40 and 50) are provided and the position of the lens 14 is detected at two positions on the outer periphery of the lens 14 (the lens unit 12), has been described. However, the present invention is not limited thereto. As in the case of a lens driving mechanism 200 shown in FIG. 6, a third sensor 210 may be provided in addition to the two sensors (the first sensor 40 and the second sensor 50) of the first embodiment and the position of the lens 14 may be detected at three positions on the outer periphery of the lens 14.

Note that in the case of a configuration in FIG. 6, it is preferable that an angle θ (SL3-SL1) formed between a third sensor line SL3 and the first sensor line SL1 is larger than 90° and an angle θ (SL3-SL2) formed between the third sensor line SL3 and the second sensor line SL2 is larger than 90°, the third sensor line SL3 being a line that is drawn from the third sensor 210 to be perpendicular to the optical axis L. In this case, the inclination of the lens 14 can be corrected more reliably.

### Fourth Embodiment

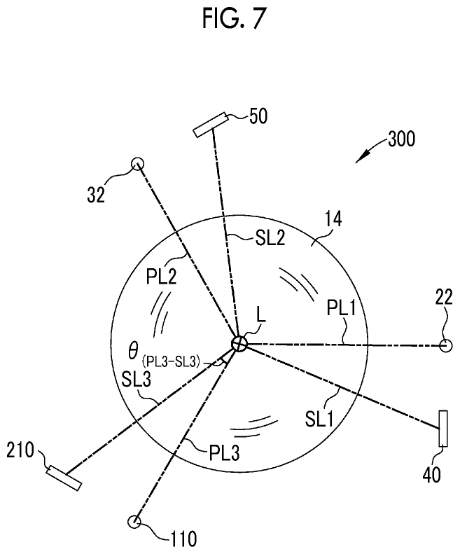

As in the case of a lens driving mechanism 300 shown in FIG. 7, a configuration may be adopted in which the third piezoelectric rod 110 of the second embodiment and the third sensor 210 of the third embodiment are provided in addition to the two piezoelectric rods (the first piezoelectric rod 22 and the second piezoelectric rod 32) and the two sensors (the first sensor 40 and the second sensor 50) of the first embodiment, a force is supplied to three positions on the outer periphery of the lens 14 so that the lens 14 is moved, and the position of the lens 14 is detected at three positions on the outer periphery of the lens 14.

Note that in the case of a configuration in FIG. 7, it is preferable that the position of the third piezoelectric rod 110 and the position of the third sensor 210 are close to each other (specifically, it is preferable that an angle θ (PL3-SL3) formed between the third piezoelectric line PL3 and the third sensor line SL3 is smaller than 90°). In this case, the position (the inclination) of the lens 14 can be controlled with high accuracy.

### EXPLANATION OF REFERENCES

10: lens driving mechanism
12: lens unit
14: lens
16: lens holding frame
16a, 16b: slide hole
20: first driving unit
21: first piezoelectric element
22: first piezoelectric rod (first shaft)
23: first support frame
23b, 23c: through hole
24: first sliding portion
24a: cutout portion
24b: leaf spring
24c: fixation portion
30: second driving unit
31: second piezoelectric element
32: second piezoelectric rod (second shaft)
33: second support frame
33b, 33c: through hole
34: second sliding portion
34a: cutout portion
34b: leaf spring
34c: fixation portion
40: first sensor
41: first detection piece
50: second sensor
51: second detection piece
60: lens control circuit (lens control device)
70: base
70a, 70b: slide shaft
100: lens driving mechanism
110: third piezoelectric rod (third shaft)
200: lens driving mechanism
210: third sensor
300: lens driving mechanism
L: optical axis
PL1: first piezoelectric line
SL1: first sensor line
PL2: second piezoelectric line
SL2: second sensor line
θ (PL1-SL1): angle formed between first piezoelectric line and first sensor line
θ (PL2-SL2): angle formed between second piezoelectric line and second sensor line
θ (PL1-PL2): angle formed between first piezoelectric line and second piezoelectric line
θ (SL1-SL2): angle formed between first sensor line and second sensor line
PL3: third piezoelectric line
SL3: third sensor line
θ (PL3-PL1): angle formed between third piezoelectric line and first piezoelectric line
θ (PL3-PL2): angle formed between third piezoelectric line and second piezoelectric line
θ (SL3-SL1): angle formed between third sensor line and first sensor line
θ (SL3-SL2): angle formed between third sensor line and second sensor line
θ (PL3-SL3): angle formed between third piezoelectric line and third sensor line

What is claimed is:

1. A lens driving mechanism comprising:
a first shaft and a second shaft that engage with a lens via a frictional force;
a first piezoelectric element that causes the first shaft to vibrate so that the lens is moved in the direction of an optical axis of the lens;
a second piezoelectric element that causes the second shaft to vibrate so that the lens is moved in the optical axis direction;
a first sensor and a second sensor that detect a position of the lens in the optical axis direction; and
a lens control device that controls the position and/or an angle of the lens based on output of the first sensor and the second sensor.

2. The lens driving mechanism according to claim 1,
wherein an angle formed between a first piezoelectric line and a first sensor line is smaller than 90° and an angle formed between a second piezoelectric line and a second sensor line is smaller than 90°, the first piezoelectric line being a line that is drawn from the first shaft to be perpendicular to the optical axis, the first sensor line being a line that is drawn from the first sensor to be perpendicular to the optical axis, the second piezoelectric line being a line that is drawn from the second shaft to be perpendicular to the optical axis, and the second sensor line being a line that is drawn from the second sensor to be perpendicular to the optical axis.

3. The lens driving mechanism according to claim 2,
wherein an angle formed between the first piezoelectric line and the second piezoelectric line is larger than 90° and an angle formed between the first sensor line and the second sensor line is larger than 90°.

4. The lens driving mechanism according to claim 3,
wherein the angle formed between the first piezoelectric line and the second piezoelectric line is 180°.

5. The lens driving mechanism according to claim 3,
wherein the angle formed between the first sensor line and the second sensor line is 180°.

6. The lens driving mechanism according to claim 1, further comprising:
a third shaft that engages with the lens via a frictional force; and
a third piezoelectric element that causes the third shaft to vibrate so that the lens is moved in the optical axis direction.

7. The lens driving mechanism according to claim 1, further comprising:
a third sensor that detects the position of the lens in the optical axis direction.

8. The lens driving mechanism according to claim 1, further comprising:
a third shaft that engages with the lens via a frictional force;
a third piezoelectric element that causes the third shaft to vibrate so that the lens is moved in the optical axis direction; and
a third sensor that detects the position of the lens in the optical axis direction.

9. The lens driving mechanism according to claim 8,
wherein an angle formed between a third piezoelectric line and a third sensor line is smaller than 90°, the third piezoelectric line being a line that is drawn from the third shaft to be perpendicular to the optical axis and the third sensor line being a line that is drawn from the third sensor to be perpendicular to the optical axis.

10. The lens driving mechanism according to claim 6,
wherein an angle formed between a third piezoelectric line and a first piezoelectric line and an angle formed between the third piezoelectric line and a second piezoelectric line are larger than 90°, the first piezoelectric line being a line that is drawn from the first shaft to be perpendicular to the optical axis, the second piezoelectric line being a line that is drawn from the second shaft to be perpendicular to the optical axis, and the third piezoelectric line being a line that is drawn from the third shaft to be perpendicular to the optical axis.

11. The lens driving mechanism according to claim 7,
wherein an angle formed between a third sensor line and a first sensor line and an angle formed between the third sensor line and a second sensor line are larger than 90°, the first sensor line being a line that is drawn from the first sensor to be perpendicular to the optical axis, the second sensor line being a line that is drawn from the second sensor to be perpendicular to the optical axis, and the third sensor line being a line that is drawn from the third sensor to be perpendicular to the optical axis.
